(19) United States
(12) Patent Application Publication
(10) Pub. No.: US 2024/0339262 A1
(43) Pub. Date: Oct. 10, 2024

(54) MAGNETIC COMPONENT

(71) Applicant: Murata Manufacturing Co., Ltd., Nagaokakyo-shi (JP)

(72) Inventor: Takami MUTO, Westborough, MA (US)

(21) Appl. No.: 18/625,328

(22) Filed: Apr. 3, 2024

Related U.S. Application Data
(60) Provisional application No. 63/457,903, filed on Apr. 7, 2023.

(51) Int. Cl. H01F 27/34; H01F 27/24; H01F 27/28

(52) U.S. Cl. CPC H01F 27/346; H01F 27/24; H01F 27/2823

(57) ABSTRACT

A magnetic component includes a core including first and second protrusions extending in a first direction, a first conductor including a first flat wire that defines a first turn that extends around the first protrusion such that a smallest dimension of the first flat wire is parallel or substantially parallel to the first direction, and a second conductor including a second flat wire that defines a second turn that extends around the second protrusion such that a smallest dimension of the second flat wire is parallel or substantially parallel to the first direction. The first and the second turns are adjacent to each other and are off set in two dimensions to define a gap between adjacent turns of the first and the second conductors.

### CROSS REFERENCE TO RELATED APPLICATIONS

This application claims the benefit of U.S. Patent Application No. 63/457,903 filed on Apr. 7, 2023. The entire contents of this application are hereby incorporated by reference.

### BACKGROUND OF THE INVENTION

### 1. Field of the Invention

The present invention relates to magnetic components. More specifically, the present invention relates to the gap structure of a magnetic component that can be used to control leakage inductance.

### 2. Description of the Related Art

It is known that a magnetic component, such as an inductor or a transformer, can be embedded in a converter. In the magnetic component, leakage inductance allows converters to function with a wide bandwidth or a wide operation frequency. In the conventional technology, the amount of leakage inductance cannot be controlled. Leakage inductance can be generated in a gap in a magnetic core. But, because it is difficult to achieve the desired leakage inductance only in a gap of a certain distance, it is necessary to control the width of the gap to a certain distance. In other words, leakage inductance is difficult to accurately control, even if the gap is too narrow or too wide.

FIG. 1 shows a known magnetic component 100 that includes conductors 110, top core 120, and bottom core 130. The conductors 110 include turns 110a that wind around protrusions 130a in the bottom core 130 or protrusion in the top core 120 and include feet 110b that can be mounted to a substrate, for example, a printed circuit board (PCB). FIG. 1 shows the magnetic component 100 with four conductors 110, and the four conductors 110 include a flat wire. The turns 110a of the four conductors 110 of the magnetic component 100 are co-planar with each other, and each of the feet 110b extends perpendicular or substantially perpendicular within manufacturing and/or measurement tolerances to the plane defined by the turns 110a so that the four conductors 110 can be connected to substrates that are parallel or substantially parallel within manufacturing tolerances with the plane defined by the turns 110a. In FIG. 1, the gap between adjacent turns 110a of the conductors 110 is only in one dimension (i.e., the gap is a horizontal gap), making it difficult to control the leakage inductance.

### SUMMARY OF THE INVENTION

To overcome the problems described above, example embodiments of the present invention provide magnetic components in which adjacent turns of first and second flat-wire conductors are off-set in two dimensions to define a gap between adjacent turns of the first and the second flat-wire conductors, allowing the leakage inductance to be easily controlled.

According to an example embodiment of the present invention, a magnetic component includes a core including first and second protrusions extending in a first direction, a first conductor including a first flat wire that defines a first turn that extends around the first protrusion such that a smallest dimension of the first flat wire is parallel or substantially parallel to the first direction, and a second conductor including a second flat wire that defines a second turn that extends around the second protrusion such that a smallest dimension of the second flat wire is parallel or substantially parallel to the first direction. The first and the second turns are adjacent to each other and are off set in two dimensions to define a gap between adjacent turns of the first and the second conductors.

A first plane defined by the first turn and a second plane defined by the second turn do not have to be co-planar. The first conductor can include first and second feet that extend in opposite directions, and the second conductor can include first and second feet that extend in opposite directions. The first turn can be either a single full turn or a single three-quarters turn, and the second turn can be either a single full turn or a single three-quarters turn.

The core can include a top core and a bottom core. A top gap corner of the top core and a bottom gap corner of the bottom core closest to the gap can be chamfered. A top component corner of the top core opposite to the top gap corner and a bottom component corner of the bottom core opposite to the bottom gap corner can both be notched.

According to an example embodiment of the present invention, a magnetic component assembly includes top and bottom substrates and the magnetic component of one of the various other example embodiments of the present invention attached between the top and bottom substrates.

The magnetic component assembly can further include first electronic components on a top surface of the top substrate.

The magnetic component assembly can further include top second electronic components attached to a bottom surface of the top substrate and bottom second electronic components attached to a top surface of the bottom substrate. The core can include a top component corner that is adjacent to the top substrate and that is notched to accommodate the top second electronic components and a bottom component corner that is adjacent to the bottom substrate and that is notched to accommodate the bottom second electronic components.

According to an example embodiment of the present invention, a magnetic component includes a core including a top core including a top surface and a bottom surface that is not parallel with the top surface; a bottom core including a top surface and a bottom surface that is not parallel with the top surface, the top surface of the top core and the bottom surface of the bottom core are parallel or substantially parallel; and first and second grooves extending through the core, a first conductor including a first flat wire that extends through the first groove such that a smallest dimension of the first flat wire is not parallel with a smallest dimension of the core, and a second conductor including a second flat wire that extends through the second groove such that a smallest dimension of the second flat wire is not parallel with the smallest dimension of the core. The first and the second grooves and the first and the second conductors are arranged to define a gap between adjacent turns of the first and the second conductors.

A first plane defined by the first conductor and a second plane defined by the second conductor can be co-planar or substantially co-planar. The first conductor can include first and second feet that extend in opposite directions, and the second conductor can include first and second feet that extend in opposite directions. A height of the gap can be less than a height of the first conductor and/or the second conductor. The first and the second grooves can be included in the top core and/or the bottom core. The top surface of the top core can include a top component corner that is notched, and the bottom surface of the bottom core can include a bottom component corner that is notched.

According to an example embodiment of the present invention, a magnetic component assembly includes top and bottom substrates and the magnetic component of one of the various other example embodiments of the present invention attached between the top and bottom substrates.

The magnetic component assembly can further include first electronic components on a top surface of the top substrate.

The magnetic component assembly can further include top second electronic components attached to a bottom surface of the top substrate and bottom second electronic components attached to a top surface of the bottom substrate. The top surface of the top core can include a top component corner that is notched to accommodate the top second electronic components, and the bottom surface of the bottom core can include a bottom component corner that is notched to accommodate the bottom second electronic components.

The above and other features, elements, characteristics, steps, and advantages of the present invention will become more apparent from the following detailed description of example embodiments of the present invention with reference to the attached drawings.

### BRIEF DESCRIPTION OF THE DRAWINGS

FIG. 1 is a perspective view of a known magnetic component in which the turns of the flat-wire coils are co-planar.

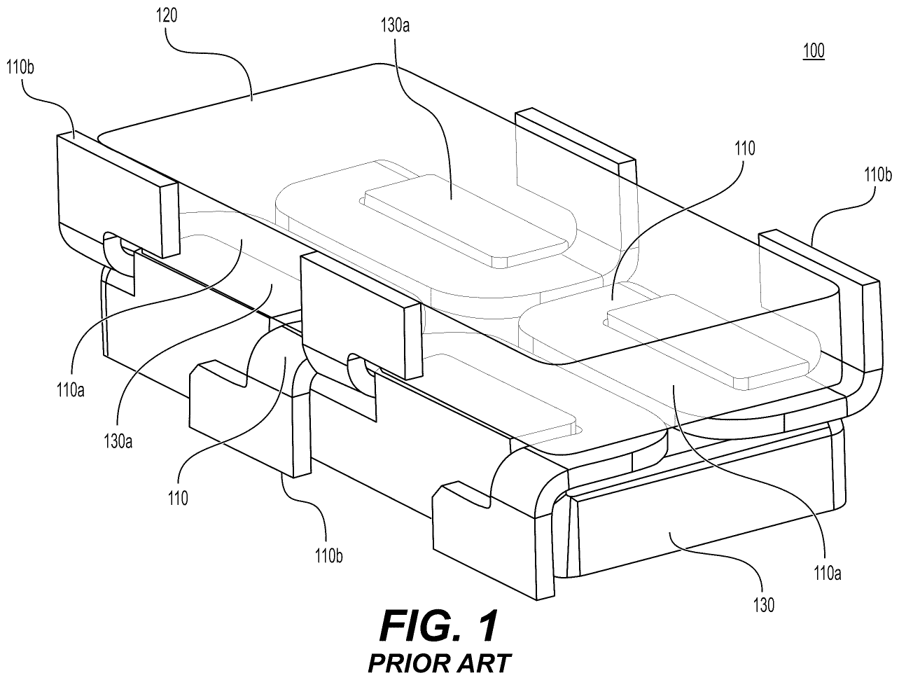

FIG. 2 is a perspective view of a magnetic component according to a first example embodiment of the present invention in which the turns of the flat-wire coils are not co-planar.

FIG. 3 is a perspective view of the magnetic component of FIG. 2 with the top magnetic core shown as transparent.

FIG. 4 is a perspective view of the flat-wire coils of the magnetic component of FIG. 2.

FIG. 5 is a side view of the magnetic component of FIG. 2.

FIG. 6 is a perspective view of a magnetic component according to a second example embodiment of the present invention in which adjacent corners of the magnetic cores are chamfered and opposite corners are notched.

FIG. 7 is a perspective view of the magnetic component of FIG. 6 with the top printed circuit board removed.

FIG. 8 is a perspective view of the magnetic component of FIG. 7 with the top magnetic core shown as transparent.

FIG. 9 is a side view of the magnetic component of FIG. 6.

FIG. 10 is a perspective view of a magnetic component according to a third example embodiment of the present invention in which a cross-section of the magnetic cores is trapezoidal.

FIG. 11 is a perspective view of the magnetic component of FIG. 10 with the top magnetic core shown as transparent.

FIG. 12 is a side sectional view of the magnetic component of FIG. 10.

FIG. 13 is a perspective view of a magnetic component according to a third example embodiment of the present invention in which a cross-section of the magnetic cores is trapezoidal and in which opposite corners of the magnetic cores are notched.

FIG. 14 is a perspective view of the magnetic component of FIG. 13 with the top magnetic core shown as transparent.

FIG. 15 is a side sectional view of the magnetic component of FIG. 13.

### DETAILED DESCRIPTION OF EXAMPLE EMBODIMENTS

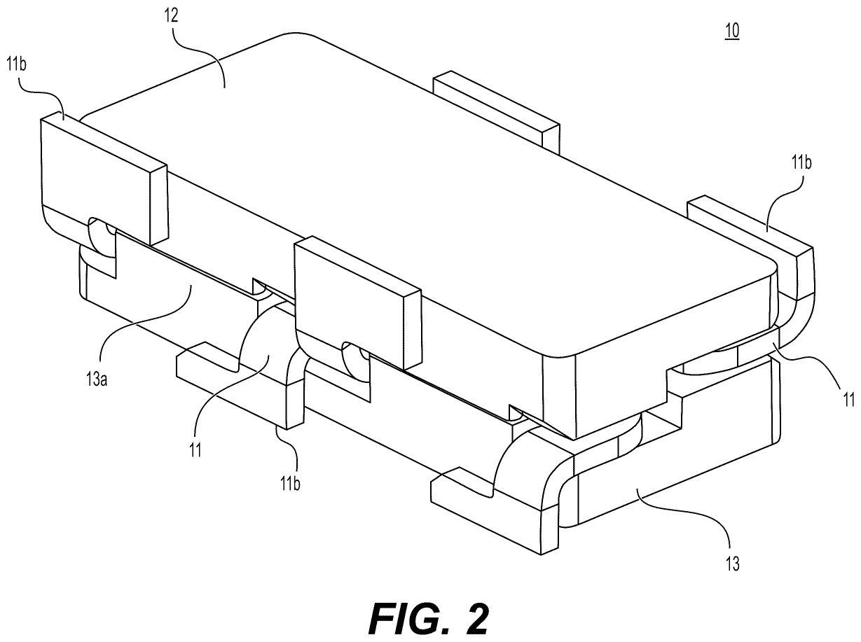

FIGS. 2-5 show a magnetic component 10 according to the first example embodiment of the present invention. The magnetic component 10 includes conductors 11 and a core with a top core 12 and a bottom core 13.

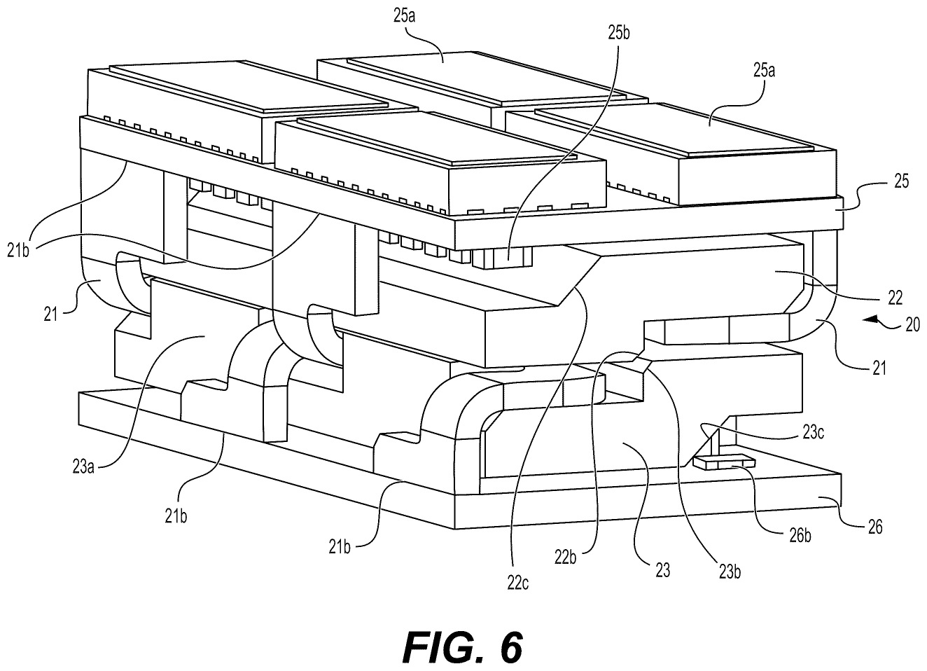

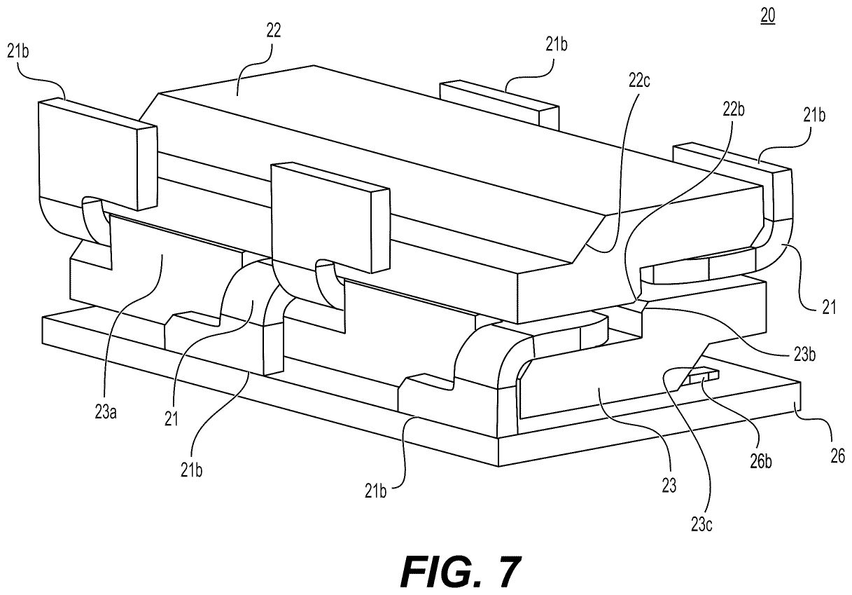

As shown in FIGS. 2-5, the magnetic component 10 can include four conductors 11, but any number of conductors 11 equal to or greater than two can be used. Each conductor 11 can be defined by a flat wire. Each conductor 11 can include copper, brass, or other suitable conductive material(s). The width of the flat wire can be greater than the thickness of the flat wire. The conductors 11 can include two feet 11b connected by a turn 11a. The two feet 11b can extend in opposite directions (e.g., up and down directions) so that the conductor 11 can be connected to two opposing, parallel substrates (not shown in FIGS. 2-5 but shown as top and bottom substrates 25, 26 in FIGS. 6-9), or the two feet 11b can extend in the same direction so that the conductor 11 can be connected to the same substrate (not shown). The substrates can be, for example, printed circuit boards (PCBs) or other suitable substrates. A magnetic component assembly can include the magnetic component 10 connected to one or two substrates.

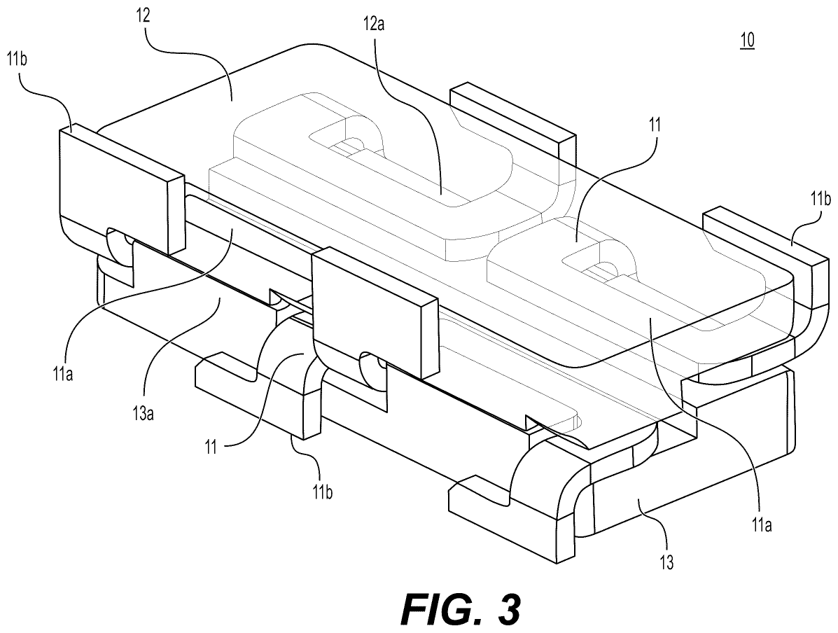

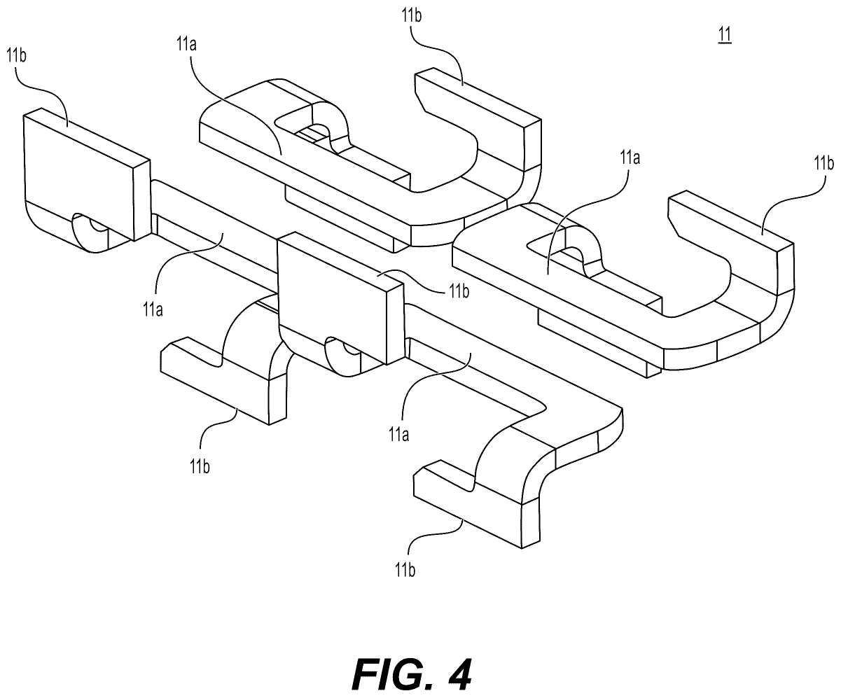

Protrusions 12a, 13a can extend from the top core 12 or the bottom core 13 along a first direction. The number of protrusions 12a, 13a can be the same as the number of conductors 11. The protrusions 12a, 13a can have any suitable cross-sectional shape including the rectangular cross-sectional shape shown in FIG. 3. A turn 11a of each of the conductors 11 can wind or extend around a corresponding protrusion 12a or 13a. As shown in FIGS. 3 and 4, the turn 11a can be a single turn, including, for example, a single three-quarters turn or a single full turn. The surface of the flat wire of the turn 11a defined by the width direction is perpendicular or substantially perpendicular to the first direction within manufacturing and/or measurement tolerances, i.e., the thickness or smallest dimension of the flat wire is parallel or substantially parallel to first direction within manufacturing and/or measurement tolerances.

In FIGS. 2, 3, and 5, the core can include two portions: top core 12 and bottom core 13, but any number of portions can be used. For example, the core can include a single portion or can include three or more portions. The core, including the top and the bottom cores 12, 13, can be made of ferrite, such as MnZn ferrite, or any other suitable magnetic material.

In FIGS. 2-5, the protrusions 12a extend only from the bottom core 12 and the protrusions 13a extend only from the bottom core 13 in which the protrusions 12a, 13a are arranged such that they are not aligned with each other, but other arrangements are possible. For example, protrusions can extend only from the top core 12, protrusions can extend only from the bottom core 13, or protrusions can extend from both the top and the bottom cores 12, 13 such that the protrusions are aligned with each other.

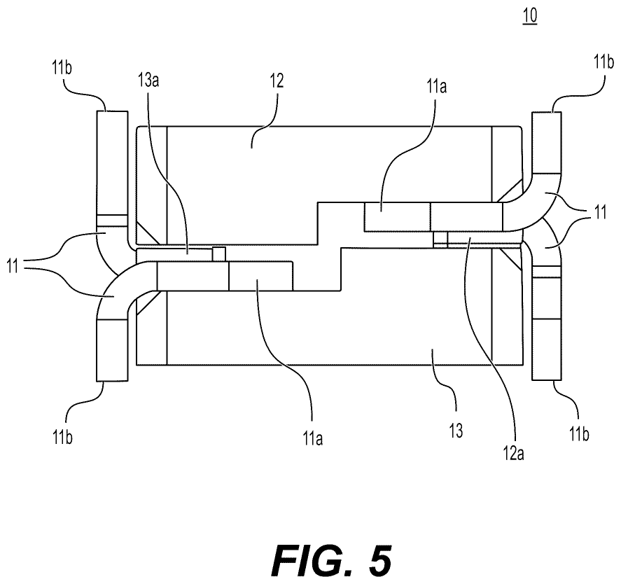

FIG. 5 shows that the planes defined by adjacent turns 11a of the conductors 11 are not co-planar. Adjacent first and second turns 11a are off set in two dimensions to define a gap between the adjacent turns 11a. The leakage inductance is determined by the geometry of the first and second turns 11a, particularly the distance between the first and second turns 11a. Changing the distance between the first and the second turns 11a changes the leakage inductance. Increasing the distance between the first and the second turns 11a increases the leakage inductance. A desired leakage inductance can be generated by a gap with a particular distance between the first and the second turns 11a. The leakage inductance can be more easily generated in the gap off set in two dimensions. That is, the internal step defined by the top and the bottom cores 12, 13 allows that leakage inductance to be more easily determined.

FIGS. 6-9 show a magnetic component 20 according to the second example embodiment of the present invention. The magnetic component 20 includes conductors 21 and a core with a top core 22 and a bottom core 23. FIG. 6 shows the magnetic component 20 mounted between a top substrate 25 and a bottom substrate 26 to define a magnetic component assembly. The top and bottom substrates 25, 26 can be, for example, a PCB or other suitable substrate. Electronic components 25a can be mounted to the top the top substrate 25, electronic components 25b can be located on the bottom surface of the top substrate 25, and electronic components 26b can be located on the top surface of the bottom substrate 26. The electronic components 25a, 25b, 26b can be, for example, active components such as integrated circuits (ICs), transistors, etc. or passive components such resistors, capacitors, inductors, etc. Top and bottom substrates 25, 26, possibly including electronic components 25a, 25b, 26b, can be used with the other example embodiments of the present invention. The electronic components 25a can be referred to as first electronic components, the electronic component 25b can be referred to as top second electronic components, and the electronic components 26b can be referred to as bottom second electronic components.

As shown in FIGS. 6-9, the magnetic component 20 can include four conductors 21, but any number of conductors 21 equal to or greater than two can be used. Each conductor 21 can be defined by a flat wire. Each conductor 21 can include copper, brass, or other suitable conductive material(s). The width of the flat wire can be greater than the thickness of the flat wire. The conductors 21 can include two feet 21b connected by a turn 21a. The two feet 21b can extend in opposite directions (e.g., up and down directions) so that the conductor 21 can be connected to the two opposing, parallel top and bottom substrates 25, 26, or the two feet 21b can extend in the same direction so that the conductor 21 can be connected to the same substrate (not shown). The turn 21a can wind around a corresponding protrusion 23a.

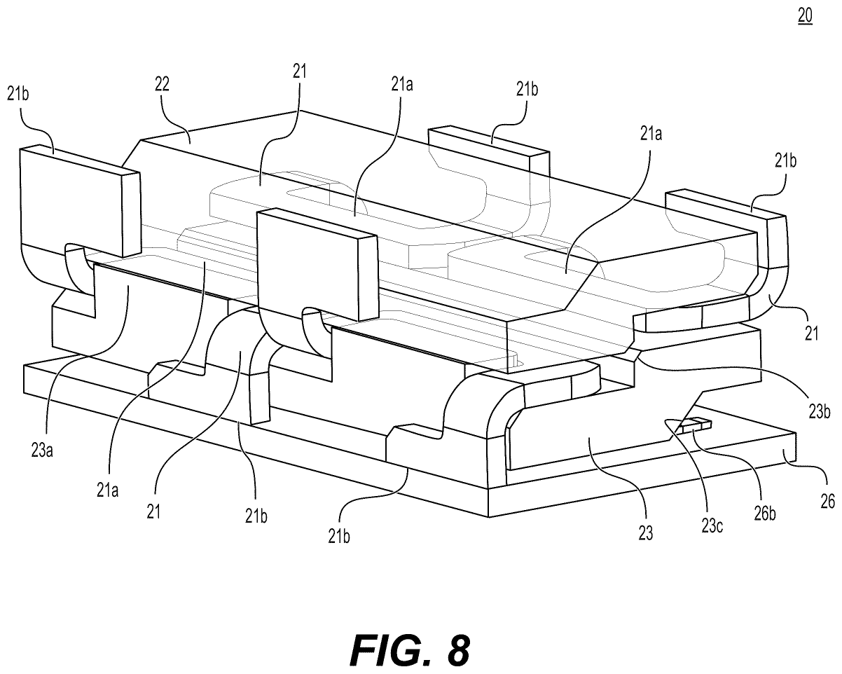

Protrusions 22a, 23a can extend from the top core 22 or the bottom core 23 along a first direction. The number of protrusions 22a, 23a can be the same as the number of conductors 21. The protrusions 22a, 23a can have any suitable cross-sectional shape including the rectangular cross-sectional shape shown in FIG. 8. A turn 21a of each of the conductors 21 can wind or extend around a corresponding protrusion 22a or 23a. A shown in FIG. 8, the turn 21a can be a single turn, including, for example, a single three-quarters turn or a single full turn. The surface of the flat wire of the turn 21a defined by the width direction is perpendicular or substantially perpendicular to the first direction within manufacturing and/or measurement tolerances, i.e., the thickness or smallest dimension of the flat wire is parallel or substantially parallel to first direction within manufacturing and/or measurement tolerances.

In FIGS. 6-9, the core can include two portions: top core 12 and bottom core 13, but any number of portions can be used. For example, the core can include a single portion or can include three or more portions. The core, including the top and the bottom cores 12, 13, can be made of ferrite, such as MnZn ferrite, or any other suitable magnetic material.

In FIGS. 6-9, the protrusions 22a extend only from the bottom core 22 and the protrusions 23a extend only from the bottom core 23 in which the protrusions 22a, 23a are arranged such that they are not aligned with each other, but other arrangements are possible. For example, protrusions can extend only from the top core 22, protrusions can extend only from the bottom core 23, or protrusions can extend from both the top and the bottom cores 22, 23 such that the protrusions are aligned with each other.

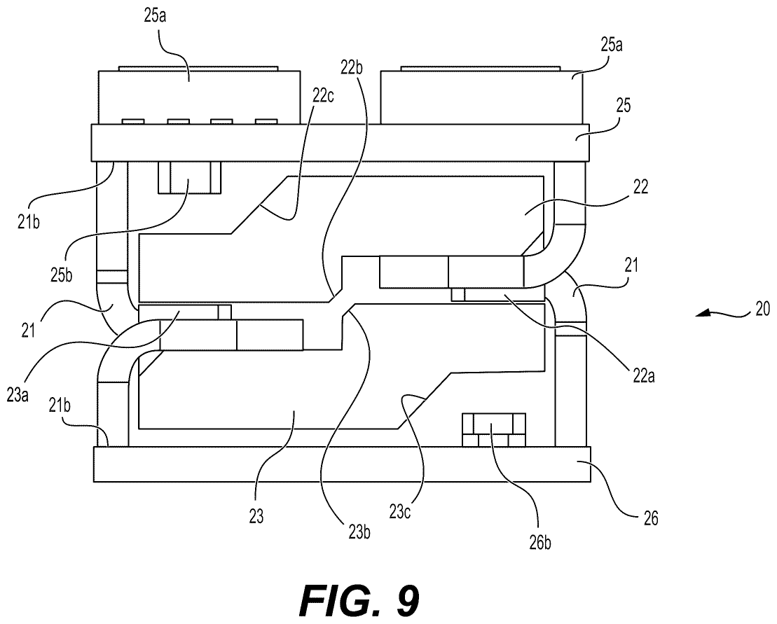

FIG. 9 shows that the planes defined by adjacent turns 21a of the conductors 21 are not co-planar. Adjacent first and second turns 21a are off set in two dimensions to define a gap between the adjacent turns 21a. The leakage inductance is determined by the geometry of the first and second turns 21a, particularly the distance between the first and second turns 21a. Changing the distance between the first and the second turns 21a changes the leakage inductance. Increasing the distance between the first and the second turns 21a increases the leakage inductance. A desired leakage inductance can be generated by a gap with a particular distance between the first and the second turns 21a. The leakage inductance can be more easily generated in the gap off set in two dimensions. That is, the internal step defined by the top and the bottom cores 22, 23 allows that leakage inductance to be more easily determined.

As shown in FIGS. 6-9 and in FIGS. 2-5, the top and bottom cores 22, 23 are different from the top and bottom cores 12, 13. Two differences are that the top core 22 can include a corner 22b and that the bottom core 23 can include a corner 23b. The corners 22b, 23b are the corners closest to the gap between adjacent turns 21a, extend along the length of the magnetic component, and can be chamfered. The corners 22b, 23b allow the top and the bottom cores 22, 23 to be closer together, which can allow for miniaturization of the magnetic component 20. The corners 22b, 23b can be referred to as top or bottom gap corners.

Additional differences in the top and bottom cores 22, 24 are that the top core 22 can include a corner 22c in the top surface of the top core 22 (e.g., opposite to the corner 22b) that is notched and that the bottom core 23 can include a corner 23c in the bottom surface of the bottom core (e.g., opposite to the corner 23b) that is notched. The corners 22c, 23c can be notched to accommodate the corresponding electronic components 25b, 26b, which allows for miniaturization of the magnetic component assembly. The inclusion of corners 22b, 23b in addition to the corners 22c, 23c can increase the amount of space available to accommodate the corresponding electronic components 25b, 26b, which can allow for further miniaturization of the magnetic component assembly. The corners 22c, 23c can be referred to as top or bottom component corners.

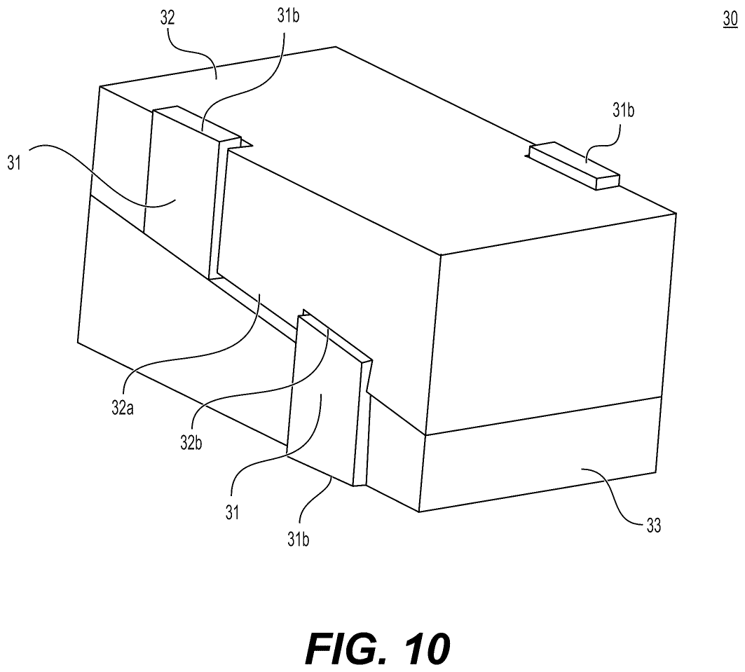

FIGS. 10-12 show a magnetic component 30 according to the third example embodiment of the present invention. The magnetic component 30 includes conductors 31 and a core with a top core 32 and a bottom core 33.

As shown in FIGS. 10-12, the magnetic component 30 can include two conductors 31, but any number of conductors 31 equal to or greater than two can be used. Each conductor 31 can be defined by a flat wire. Each conductor 31 can include copper, brass, or other suitable conductive material(s). The width of the flat wire can be greater than the thickness of the flat wire. The conductors 31 can include two feet 31b connected by a turn 31a. The two feet 31b can extend in opposite directions (e.g., up and down directions) so that the conductor 31 can be connected to two opposing, parallel substrates (not shown in FIGS. 10-12 but shown as top and bottom substrates 25, 26 in FIGS. 6-9), or the two feet 31b can extend in the same direction so that the conductor 31 can be connected to the same substrate (not shown). The substrates can be, for example, printed circuit boards (PCBs) or other suitable substrates. A magnetic component assembly can include the magnetic component 30 connected to one or two substrates.

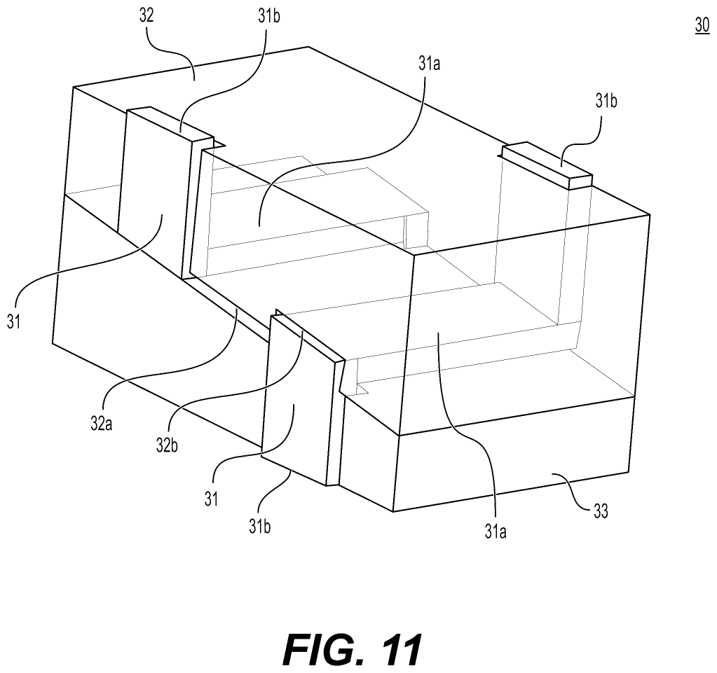

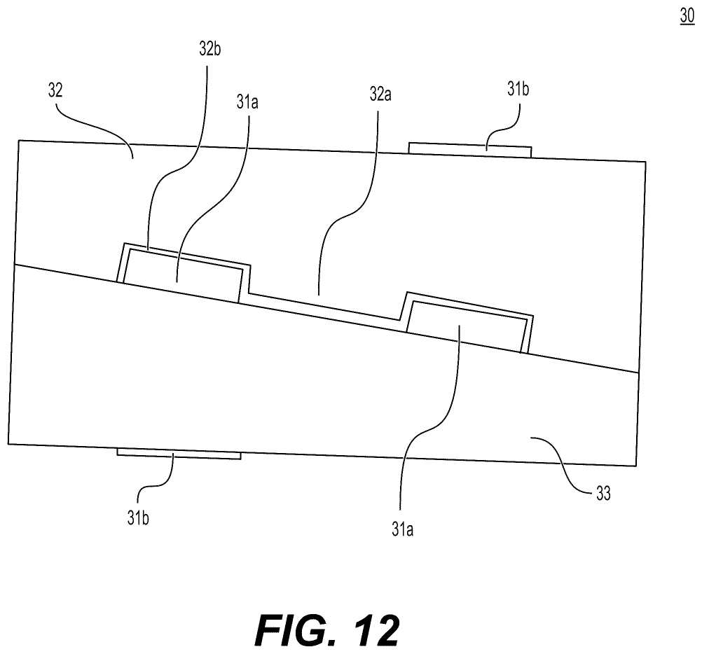

Grooves 32b can extend along a bottom surface of the top core 32 along a first direction. The number of grooves 32b can be the same as the number of conductors 31. The grooves 32b can have any suitable cross-sectional shape including the rectangular cross-sectional shape shown in the cross-section view of FIG. 12. A turn 31a of each of the conductors 31 can extend through a corresponding groove 32b. A shown in FIG. 11, the turn 31a can be a single turn, including, for example, a single quarter turn. The surface of the flat wire of the turn 31a defined by the width direction is not parallel with a top surface of the top core 32 and is not parallel with a bottom surface of the bottom core 33, i.e., the thickness or smallest dimension of the flat wire is not parallel with the thickness or smallest dimension of the core.

In FIGS. 10-12, the core can include two portions: top core 32 and bottom core 33, but any number of portions can be used. For example, the core can include a single portion or can include three or more portions. The core, including the top and the bottom cores 32, 33, can be made of ferrite, such as MnZn ferrite, or any other suitable magnetic material. As shown in FIG. 12, the cross-sectional shape of the top and the bottom cores 32, 33 can be that of a right-angle trapezoid with two adjacent right angles, an acute angle, and an obtuse angle and with two opposing parallel or substantially parallel lines within manufacturing and/or measurement tolerances and two opposing non-parallel lines. The non-parallel line connecting the obtuse and acute angles of the top core 32 (i.e., the bottom surface of the top core 32) and the non-parallel line connecting the obtuse and acute angles of the bottom core 33 (i.e., the top surface of the bottom core 33) can face each other such that the line where the top and the bottom cores 32, 33 face each is not parallel with the top surface of the top core 32 and is not parallel with the bottom surface of the bottom core 33.

As shown in FIGS. 11 and 12, the top core 32 can include a protrusion 32a such that a gap is defined between the inductors 31. Alternatively, a protrusion can be included in the bottom core 33, or a protrusion can be included in each of the top core 32 and the bottom core 33 such that a gap is defined between the conductors 31 in the top core 32 and/or the bottom core 33.

FIG. 12 shows that the planes defined by adjacent turns 31a of the conductors 31 are co-planar or substantially co-planar withing manufacturing and/or measurement tolerances but, as explained above, are not parallel with the top surface of the top core 32 and are not parallel with the bottom surface of the bottom core 33. As shown in FIG. 12, the height of the gap can be smaller than the height of the turns 31a. The leakage inductance is determined by the geometry of the first and second turns 31a, particularly the distance between the first and second turns 31a. Changing the distance between the first and the second turns 31a changes the leakage inductance. Increasing the distance between the first and the second turns 31a increases the leakage inductance. A desired leakage inductance can be generated by a gap with a particular distance between the first and the second turns 31a. The leakage inductance can be more easily generated in the gap defined by the protrusion 32a. That is, the internal step defined by the protrusion 32a allows that leakage inductance to be more easily determined.

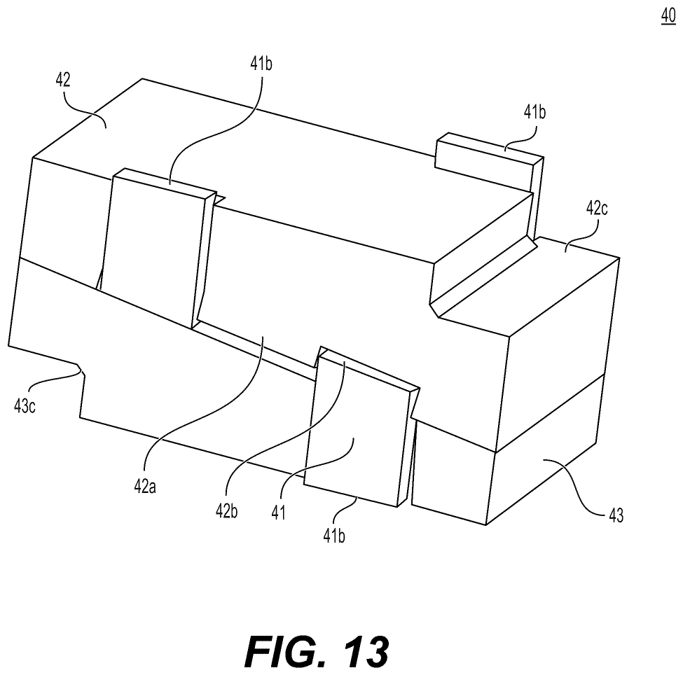

FIGS. 13-15 show a magnetic component 40 according to the fourth example embodiment of the present invention. The magnetic component 40 includes conductors 41 and a core with a top core 42 and a bottom core 43.

As shown in FIGS. 13-15, the magnetic component 40 can include two conductors 41, but any number of conductors 41 equal to or greater than two can be used. Each conductor 41 can be defined by a flat wire. Each conductor 41 can include copper, brass, or other suitable conductive material(s). The width of the flat wire can be greater than the thickness of the flat wire. The conductors 41 can include two feet 41b connected by a turn 41a. The two feet 41b can extend in opposite directions (e.g., up and down directions) so that the conductor 41 can be connected to two opposing, parallel substrates (not shown in FIGS. 13-13 but shown as top and bottom substrates 25, 26 in FIGS. 6-9), or the two feet 41b can extend in the same direction so that the conductor 41 can be connected to the same substrate (not shown). The substrates can be, for example, printed circuit boards (PCBs) or other suitable substrates. A magnetic component assembly can include the magnetic component 40 connected to one or two substrates.

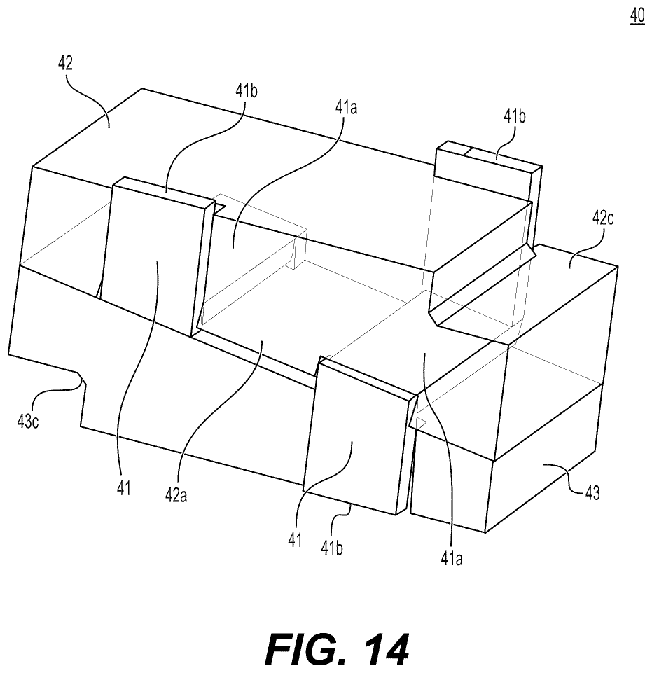

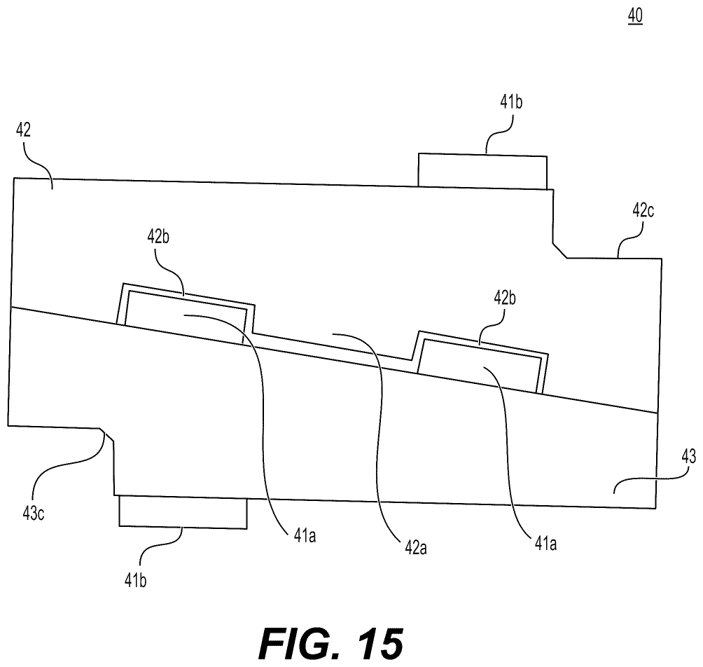

Grooves 42b can extend along a bottom surface of the top core 42 along a first direction. The number of grooves 42b can be the same as the number of conductors 41. The grooves 42b can have any suitable cross-sectional shape including the rectangular cross-sectional shape shown in the cross-section view of FIG. 15. A turn 41a of each of the conductors 41 can extend through a corresponding groove 42b. A shown in FIG. 14, the turn 31a can be a single turn, including, for example, a single quarter turn. The surface of the flat wire of the turn 41a defined by the width direction is not parallel with a top surface of the top core 42 and is not parallel with a bottom surface of the bottom core 43, i.e., the thickness or shortest dimension of the flat wire is not parallel with the thickness or shortest dimension of the core.

In FIGS. 13-15, the core can include two portions: top core 42 and bottom core 43, but any number of portions can be used. For example, the core can include a single portion or can include three or more portions. The core, including the top and the bottom cores 42, 3, can be made of ferrite, such as MnZn ferrite, or any other suitable magnetic material. As shown in FIG. 15, the cross-sectional shape of the top and the bottom cores 42, 43 can be that of a right-angle trapezoid with two adjacent right angles, an acute angle, and an obtuse angle and with two opposing parallel or substantially parallel lines within manufacturing and/or measurement tolerances and two opposing non-parallel lines. The non-parallel line connecting the obtuse and acute angles of the top core 42 (i.e., the bottom surface of the top core 42) and the non-parallel line connecting the obtuse and acute angles of the bottom core 43 (i.e., the top surface of the bottom core 43) can face each other such that the line where the top and the bottom cores 42, 43 face each is not parallel with the top surface of the top core 42 and is not parallel with the bottom surface of the bottom core 43.

As shown in FIGS. 14 and 15, the top core 42 can include a protrusion 42a such that a gap is defined between the inductors 41. Alternatively, a protrusion can be included in the bottom core 43, or a protrusion can be included in each of the top core 42 and the bottom core 43 such that a gap is defined between the conductors 41 in the top core 42 and/or the bottom core 43.

FIG. 15 shows that the planes defined by adjacent turns 41a of the conductors 41 are co-planar or substantially co-planar withing manufacturing and/or measurement tolerances but, as explained above, are not parallel with the top surface of the top core 42 and are not parallel with the bottom surface of the bottom core 43. The leakage inductance is determined by the geometry of the first and second turns 41a, particularly the distance between the first and second turns 41a. Changing the distance between the first and the second turns 41a changes the leakage inductance. Increasing the distance between the first and the second turns 41a increases the leakage inductance. A desired leakage inductance can be generated by a gap with a particular distance between the first and the second turns 41a. The leakage inductance can be more easily generated in the gap defined by the protrusion 42a. That is, the internal step defined by the protrusion 42a allows that leakage inductance to be more easily determined.

As shown in FIGS. 13-15 and in FIGS. 10-12, the top and bottom cores 42, 43 are different from the top and bottom cores 32, 33. Two differences are that the top core 42 can include a corner 42c in a top surface of the top core 43 that is notched and that the bottom core 43 can include a corner 43c in a bottom surface of the bottom core 43 that is notched. The corners 42c, 43c can be notched to accommodate the corresponding electronic components similar to how the corners 22c, 23c accommodate the corresponding electronic components 25b, 26b in the second example embodiment, which allows for miniaturization of the magnetic component assembly included the magnetic component 40.

The magnetic components 10, 20, 30, 40 can be used as an inductor or as a transformer. The magnetic component 10, 20, 30, 40 can be included in, for example, a converter, such as, for example, a DC-DC converter, a DC-AC converter, or an AC-DC converter, etc. As an example, the magnetic component 10, 20, 30, 40 can be a transformer of a converter that includes top and bottom substrate, and the electronic components on the top and bottom substrates can be the other components of the converter.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

What is claimed is:

1. A magnetic component comprising:
a core including first and second protrusions extending in a first direction;
a first conductor including a first flat wire that defines a first turn that extends around the first protrusion such that a smallest dimension of the first flat wire is parallel or substantially parallel to the first direction; and
a second conductor including a second flat wire that defines a second turn that extends around the second protrusion such that a smallest dimension of the second flat wire is parallel or substantially parallel to the first direction; wherein
the first and the second turns are adjacent to each other and are off set in two dimensions to define a gap between adjacent turns of the first and the second conductors.

2. The magnetic component of claim 1, wherein a first plane defined by the first turn and a second plane defined by the second turn are not co-planar.

3. The magnetic component of claim 1, wherein
the first conductor includes first and second feet that extend in opposite directions; and
the second conductor includes first and second feet that extend in opposite directions.

4. The magnetic component of claim 1, wherein
the first turn is either a single full turn or a single three-quarters turn; and
the second turn is either a single full turn or a single three-quarters turn.

5. The magnetic component of claim 1, wherein the core includes a top core and a bottom core.

6. The magnetic component of claim 5, wherein a top gap corner of the top core and a bottom gap corner of the bottom core closest to the gap are chamfered.

7. The magnetic component of claim 6, wherein a top component corner of the top core opposite to the top gap corner and a bottom component corner of the bottom core opposite to the bottom gap corner are both notched.

8. A magnetic component assembly comprising:
top and bottom substrates; and
the magnetic component of claim 1 attached between the top and bottom substrates.

9. The magnetic component assembly of claim 8, further comprising first electronic components on a top surface of the top substrate.

10. The magnetic component assembly of claim 8, further comprising:
top second electronic components attached to a bottom surface of the top substrate; and
bottom second electronic components attached to a top surface of the bottom substrate; wherein
the core includes:
a top component corner that is adjacent to the top substrate and that is notched to accommodate the top second electronic components; and
a bottom component corner that is adjacent to the bottom substrate and that is notched to accommodate the bottom second electronic components.

11. A magnetic component comprising:
a core including:
a top core including a top surface and a bottom surface that is not parallel with the top surface;
a bottom core including a top surface and a bottom surface that is not parallel with the top surface, the top surface of the top core and the bottom surface of the bottom core are parallel or substantially parallel; and
first and second grooves extending through the core;
a first conductor including a first flat wire that extends through the first groove such that a smallest dimension of the first flat wire is not parallel with a smallest dimension of the core; and
a second conductor including a second flat wire that extends through the second groove such that a smallest dimension of the second flat wire is not parallel with the smallest dimension of the core; wherein
the first and the second grooves and the first and the second conductors are arranged to define a gap between adjacent turns of the first and the second conductors.

12. The magnetic component of claim 11, wherein a first plane defined by the first conductor and a second plane defined by the second conductor are co-planar or substantially co-planar.

13. The magnetic component of claim 11, wherein
the first conductor includes first and second feet that extend in opposite directions; and
the second conductor includes first and second feet that extend in opposite directions.

14. The magnetic component of claim 11, wherein a height of the gap is less than a height of the first conductor and/or the second conductor.

15. The magnetic component of claim 11, wherein the first and the second grooves are included in the top core.

16. The magnetic component of claim 11, wherein the first and the second grooves are included in the bottom core.

17. The magnetic component of claim 11, wherein
the top surface of the top core includes a top component corner that is notched; and
the bottom surface of the bottom core include a bottom component corner that is notched.

18. A magnetic component assembly comprising:
top and bottom substrates; and
the magnetic component of claim 11 attached between the top and bottom substrates.

19. The magnetic component assembly of claim 18, further comprising first electronic components on a top surface of the top substrate.

20. The magnetic component assembly of claim 18, further comprising:
top second electronic components attached to a bottom surface of the top substrate; and
bottom second electronic components attached to a top surface of the bottom substrate; wherein
the top surface of the top core includes a top component corner that is notched to accommodate the top second electronic components; and
the bottom surface of the bottom core includes a bottom component corner that is notched to accommodate the bottom second electronic components.
